(19) United States
(12) Patent Application Publication
(10) Pub. No.: US 2018/0224728 A1
(43) Pub. Date: Aug. 9, 2018

(54) IMAGE DISPLAY APPARATUS AND IMAGE DISPLAY SYSTEM USING THE SAME

(71) Applicant: CANON KABUSHIKI KAISHA, Tokyo (JP)

(72) Inventors: Akihiro Otani, Utsunomiya-shi (JP); Makoto Nomoto, Saitama-shi (JP)

(21) Appl. No.: 15/889,651

(22) Filed: Feb. 6, 2018

(30) Foreign Application Priority Data
Feb. 9, 2017 (JP) 2017-022614

(51) Int. Cl. G03B 21/00; G02F 1/1335

(52) U.S. Cl. CPC G03B 21/006; G02F 1/133602; G02F 1/133621

(57) ABSTRACT

An image display apparatus includes: a light source unit that emits first to third color light with different wavelengths; first to third image modulation elements the first to third color light enters, respectively; a cooling unit that cools the image modulation elements; a temperature detecting unit that detect temperatures of the image modulation elements; and a control unit that controls the cooling unit based on detection results of the temperature detecting unit, such that a temperature difference between the first and second image modulation elements becomes a predetermined temperature difference or greater, and a temperature difference between the first and third image modulation elements becomes a predetermined temperature difference or greater. The first to third color light is green, red, and blue light, respectively. The control unit controls the cooling unit such that the temperature increases in order of the first, third, and second image modulation element.

### BACKGROUND OF THE INVENTION

### Field of the Invention

The present disclosure relates to an image display apparatus and an image display system using the image display apparatus. More particularly, the present disclosure relates to an image display apparatus that performs projection using a plurality of image modulation elements, and an image display system using the image display apparatus.

### Description of the Related Art

When a liquid crystal panel used as an image modulation element of an image display apparatus such as a projector reaches too high or too low temperatures, the liquid crystal panel may have a reduced life or a change in reflectance or transmittance characteristics. Therefore, when operating a projector, it is necessary to maintain the temperature of the liquid crystal panel to stay within a predetermined range.

As a projector that solves such a problem, a projector disclosed in Japanese Patent Laid-Open No. 2014-174515 is known. The projector disclosed in Japanese Patent Laid-Open No. 2014-174515 includes a cooling apparatus and a heating apparatus for a liquid crystal panel, and a control apparatus that controls the cooling apparatus and the heating apparatus such that a temperature of the liquid crystal panel stays within a predetermined range.

Here, in a manufacturing process of a projector using a plurality of liquid crystal panels, in order to improve image quality such as a tint and color balance, in a state where the plurality of liquid crystal panels is illuminated, an adjustment is made to a location or an angle of an optical element such as a polarizing plate and a waveplate disposed near each liquid crystal panel. In this case, a temperature difference is made between first and second liquid crystal panels by a difference between power of first color light that enters the first liquid crystal panel and power of second color light that enters the second liquid crystal panel. Therefore, when operating the projector, it is preferable to make the temperature difference between the first and second liquid crystal panels close to the temperature difference at a time of the adjustment described above.

For such knowledge, although Japanese Patent Laid-Open No. 2014-174515 discloses a configuration that allows a temperature of a liquid crystal panel to stay within a predetermined range, Japanese Patent Laid-Open No. 2014-174515 has no disclosure or suggestion regarding the temperature difference between the first and second liquid crystal panels.

### SUMMARY OF THE INVENTION

It is therefore an object of the present disclosure to provide an image display apparatus capable of cooling an image modulation element and capable of making image quality better than image quality of a conventional image display apparatus, and an image display system using the image display apparatus.

In order to achieve the object described above, an image display apparatus of the present disclosure includes:

a light source unit configured to emit first color light, second color light, and third color light with wavelengths different from each other;

a first image modulation element in which the first color light enters;

a second image modulation element in which the second color light enters;

a third image modulation element in which the third color light enters;

a cooling unit configured to cool the first, second, and third image modulation elements;

a temperature detecting unit configured to detect temperatures of the first, second, and third image modulation elements; and

a control unit configured to control the cooling unit on the basis of a detection result made by the temperature detecting unit, such that a temperature difference between the first and second image modulation elements becomes equal to or greater than a predetermined temperature difference, and a temperature difference between the first and third image modulation elements becomes equal to or greater than a predetermined temperature difference,

wherein the first color light is green color light, the second color light is red color light, and the third color light is blue color light, and

wherein on the basis of the detection result made by the temperature detecting unit, the control unit controls the cooling unit such that the temperature increases in order of the first image modulation element, the third image modulation element, and the second image modulation element.

Further features of the present disclosure will become apparent from the following description of exemplary embodiments (with reference to the attached drawings).

### BRIEF DESCRIPTION OF THE DRAWINGS

FIG. 1 is an illustration of an image modulation unit 10 according to first and second embodiments.

FIG. 2 is a control flowchart diagram of a cooling fan 32G according to the first embodiment.

FIG. 3 is a control flowchart diagram of cooling fans 32R and 32B according to the first embodiment.

FIG. 4 is a control flowchart diagram of a cooling fan 32G according to the second embodiment.

FIG. 5 is a control flowchart diagram of cooling fans 32R and 32B according to the second embodiment.

FIG. 6 is a configuration diagram of an image display apparatus according to each embodiment.

FIG. 7 is a configuration diagram of an image display system according to each embodiment.

### DESCRIPTION OF THE EMBODIMENTS

### First Embodiment

### (Configuration of Image Display Apparatus)

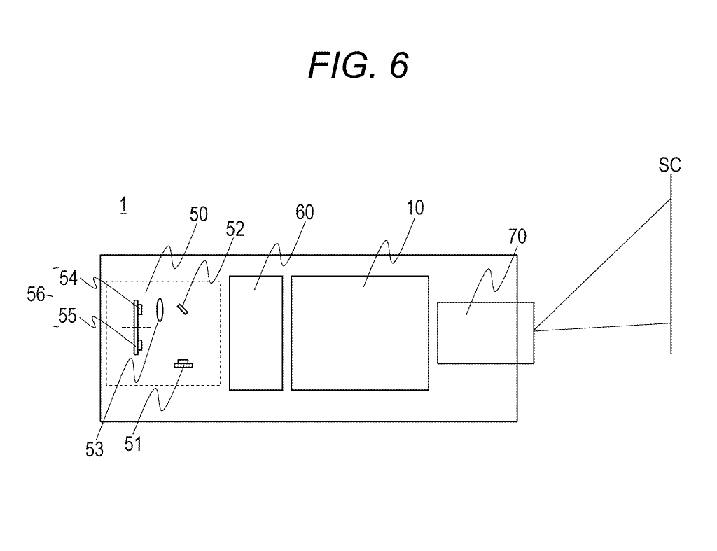

First, an overall configuration of an image display apparatus in each embodiment of the present disclosure will be described with reference to FIG. 6. A projector (image display apparatus) 1 illustrated in FIG. 6 includes a light source unit 50, an illumination optical system 60, an image modulation unit 10, and a projection lens (projection optical system) 70, thereby allowing an image formed by the image modulation unit 10 to be projected and displayed on a screen SC.

More specifically, the light source unit 50 includes an excitation light source unit 51 and a dichroic mirror 52 for guiding light from the excitation light source unit 51 to a phosphor unit 56 to be described later and for guiding light from the phosphor unit 56 to the illumination optical system 60. A condense optical system 53 is provided between the dichroic mirror 52 and the phosphor unit 56.

The phosphor unit 56 includes a circular plate 55 rotatable about a central axis and a phosphor 54 annularly provided on the circular plate 55. The excitation light source unit 51 includes one or more blue laser diodes. The phosphor 54 is a yellow color phosphor capable of emitting green color light and red color light. More specifically, the phosphor unit 56 converts part of excitation light from the excitation light source unit 51 into fluorescent light different from the excitation light in wavelength. The phosphor unit 56 also emits the fluorescent light and unconverted light identical to the excitation light in wavelength. Note that the excitation light source unit 51 includes one or more blue light laser diodes that serve as solid-state light sources. A diffusion layer that serves as a diffusion member may be provided instead of the phosphor 54 that serves as a diffusion member. When configured in this way, the excitation light source unit 51 is only required to include solid-state light sources that emit light of RGB color lights, such as laser diodes and LEDs.

The illumination optical system 60 includes first and second fly-eye lenses and condenser lenses for uniformly illuminating first to third image modulation elements to be described later by using the light from the light source unit 50, and a polarization conversion element. The image modulation unit 10 is configured as will be described later. The projection lens 70 is mountable on the projector 1.

### (Configuration of Image Modulation Unit in the Present Embodiment)

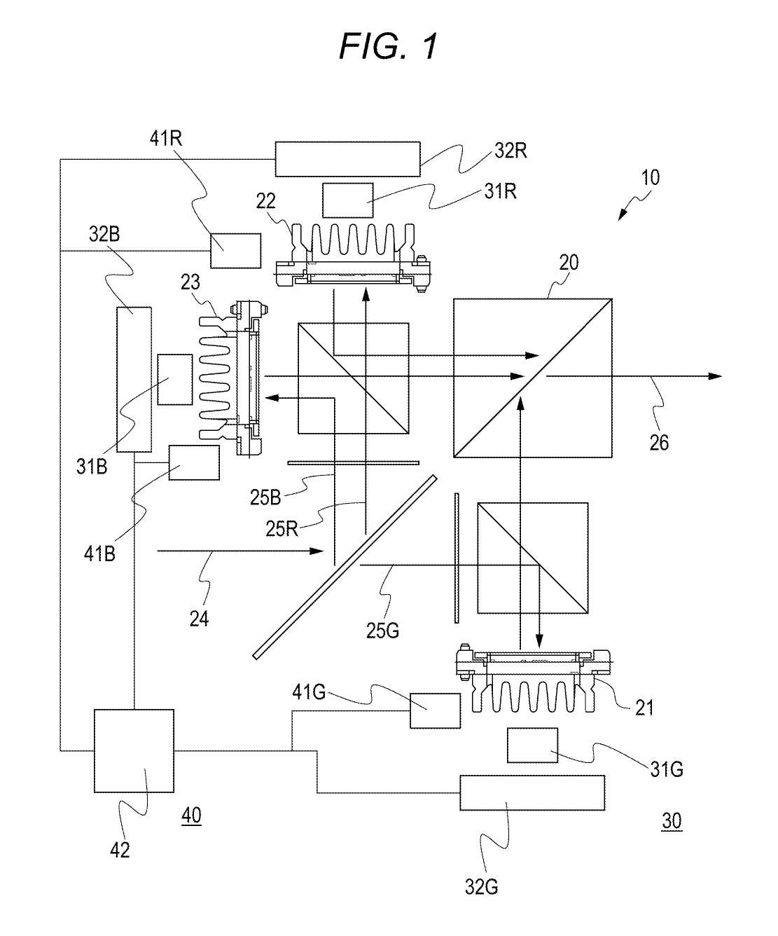

With reference to FIGS. 1 to 3, the image modulation unit 10 that can be mounted on the image display apparatus 1 according to a first embodiment will be described below.

As illustrated in FIG. 1, the image modulation unit 10 includes a color separation/combination optical system 20, a first reference panel 21 (first image modulation element), a second panel 22 (second image modulation element), and a third panel 23 (third image modulation element). Note that in the present embodiment, each panel is a reflective liquid crystal panel, but a control flow regarding cooling to be described later may be applied to an image display apparatus using a transmissive liquid crystal panel. Illumination light 24 emitted from the light source unit 50 and entering the color separation/combination optical system 20 is divided into first color light 25G, second color light 25R, and third color light 25B, and then enters the first reference panel 21, the second panel 22, and the third panel 23, respectively.

The color light 25G, the color light 25R, and the color light 25B modulated and reflected by respective panels in response to a video signal that is input into the image display apparatus 1 enter the color separation/combination optical system 20 and are combined again to become projection light 26. The projection light 26 is then emitted from the image display apparatus 1 through the projection lens 70.

Here, the color light 25G emitted on the first reference panel 21 is green color light (first color light), the color light 25R emitted on the second panel is red color light (second color light), and the color light 25B emitted on the third panel is blue color light (third color light).

When a plurality of color light beams is emitted on respective panels, the panels generate heat due to light energy of components other than components reflected by reflectance of the panels. Therefore, the image display apparatus 1 includes a panel cooling unit 30 (cooling unit) for cooling the panels and a cooling control unit 40.

The panel cooling unit 30 includes cooling ducts 31G, 31R, and 31B for guiding cooling airflow from an inlet port of the image display apparatus 1 to the first reference panel 21, the second panel 22, and the third panel 23, respectively. The panel cooling unit 30 further includes a first cooling fan 32G (first cooling unit), a second cooling fan 32R (second cooling unit), and a third cooling fan 32B (third cooling unit) for blowing the cooling airflow to the panels.

The cooling control unit 40 includes temperature detecting units 41G, 41R, and 41B (temperature detecting units) capable of detecting temperatures of respective panels themselves that generate heat by color light. The cooling control unit 40 further includes a fan output adjusting unit 42 (control unit) that adjusts output of the cooling fans 32G, 32R, and 32B that cool respective panels. More specifically, the fan output adjusting unit 42 controls a rotating speed of the first to third cooling fans. That is, the fan output adjusting unit 42 controls cooling capacity of the first to third cooling fans.

Feedback control is applied to control of output of the cooling fans 32G, 32R, and 32B by the fan output adjusting unit 42. A panel temperature necessary for performing projection with an optimum tint is set for each panel as a target temperature. A target temperature 43G is set for the first reference panel 21. Target temperature differences 43R and 43B are set between the first reference panel 21, and the second panel 22 and the third panel 23, respectively.

Output of the cooling fan 32G that cools the first reference panel 21 is calculated as follows. That is, the output of the cooling fan 32G is calculated on the basis of output necessary for maintaining the target temperature 43G of the first reference panel 21, in consideration of output adjusted with a temperature difference between the target temperature 43G and the temperature detected by the temperature detecting unit 41G.

Output of the cooling fans 32R and 32B that cool the second panel 22 and the third panel 23 is calculated as follows, respectively. That is, on the basis of output necessary for maintaining the target temperature differences 43R and 43B between the first reference panel 21, and the second panel 22 and the third panel 23, temperature differences of the temperatures detected by the temperature detecting units 41G, 41R, and 41B are calculated. Then, the output of the cooling fans 32R and 32B is calculated in consideration of output adjusted with temperature differences between the calculated temperature differences and the target temperature differences 43R and 43B, respectively.

### (Effects Obtained by the Present Embodiment)

That is, in the present embodiment, on the basis of temperature detection results of respective panels by the temperature detecting units 41G, 41R, and 41B, the fan output adjusting unit 42 controls the panel cooling unit 30 such that the temperature difference between the second panel 22 and the first reference panel 21 becomes equal to or greater than a predetermined temperature difference. By performing such control, as described above, the temperature difference between the second panel 22 and the first reference panel 21 during use of the image display apparatus 1 can be controlled close to the temperature difference at a time of adjusting a location or an angle of the optical elements such as the polarizing plate and the waveplate. Note that the temperature difference equal to or greater than a predetermined temperature difference means that the temperature difference between the second panel 22 and the first reference panel 21 is larger than 0° C.

In other words, the magnitude relationship of temperature between the second panel 22 and the first reference panel 21 at the time of adjusting a location or an angle of the optical elements can be maintained even when the image display apparatus 1 is used. As a result, it is possible to implement an image display apparatus capable of cooling the image modulation element and capable of making image quality better than image quality of a conventional image display apparatus.

### (More Preferred Form)

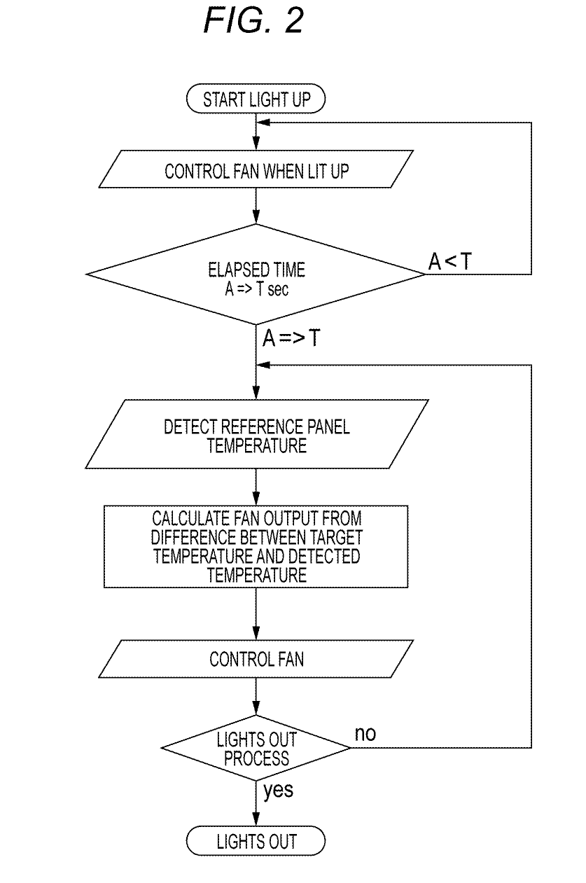

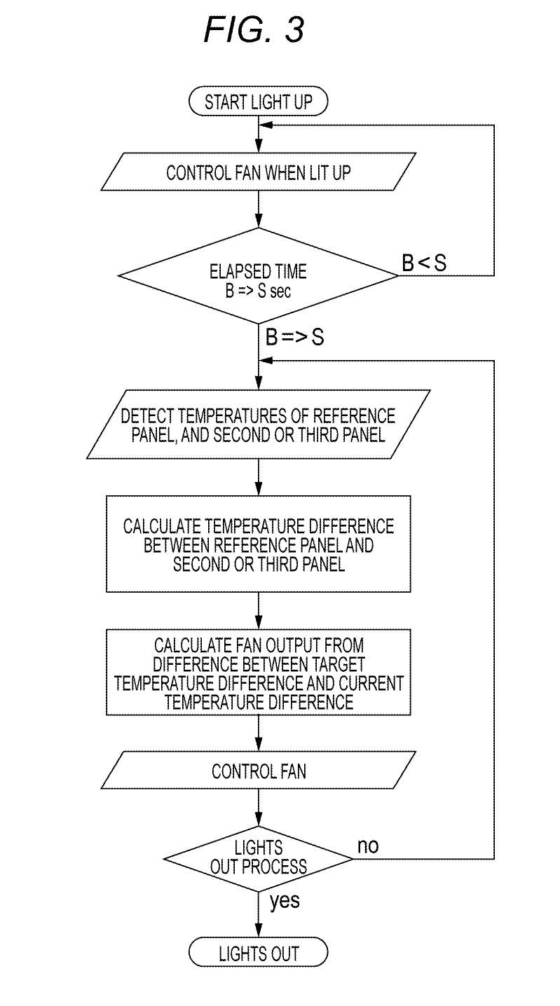

Next, a control flow as a more preferred form of the present embodiment will be described with reference to FIGS. 2 and 3. FIG. 2 is a control flowchart diagram of the cooling fan 32G that cools the first reference panel 21. FIG. 3 is a control flowchart diagram of the cooling fans 32R or 32B that cool the second panel 22 and the third panel 23, respectively.

First, the control flowchart of the cooling fan 32G for the first reference panel 21 of FIG. 2 will be described.

Immediately after the image display apparatus 1 is activated and the light source is lit up, the cooling fan 32G cools the first reference panel 21 with preset initial fan output. After light up start, when a time T elapses that is set in consideration of light source output and initial output of the cooling fan 32G, the following control is performed. That is, the cooling fan 32G is controlled by feedback control that adjusts output according to a difference between the following two bases. One of the bases is the target temperature 43G of the first reference panel 21. The other is the current temperature detected by the temperature detecting unit 41G. The feedback control of the output to the cooling fans 32R and 32B continues until a lights-out instruction is provided to the image display apparatus 1.

Next, the control flowchart of the cooling fans 32R and 32B for the second panel 22 and the third panel 23 of FIG. 3 will be described.

Immediately after the image display apparatus 1 is activated and the light source is lit up, the cooling fans 32R and 32B cool the second panel 22 and the third panel 23 with preset initial fan output, respectively.

After a time S elapses that is set in consideration of the light source output and initial output of the cooling fans 32R and 32B, the following control is performed. That is, the cooling fans 32R and 32B are controlled by the feedback control for adjusting the output according to a difference between the following two temperature differences. One of the two temperature differences is the target temperature differences 43R and 43B. The other is the temperature differences calculated from the current temperatures detected by the temperature detecting units 41G, 41R, and 41B for detecting the temperatures of respective panels. The feedback control of the output to the cooling fans 32R and 32B continues until a lights-out instruction is provided to the image display apparatus 1.

That is, in the present embodiment, the fan output adjusting unit 42 does not perform the above-described control based on the detection results made by the temperature detecting units 41G, 41R, and 41B until a predetermined time elapses since the light source unit 50 is lit up. Then, after the predetermined time elapses, the above-described control is performed. Consider a case where the above-described control is performed immediately after the light source unit 50 is lit up. In this case, since the temperature of the first reference panel 21 is the same as the temperature of the second panel 22 immediately after the light source unit 50 is lit up, the rotating speed of the second cooling fan 32R may abruptly increase so as to abruptly decrease the temperature of the second panel 22, leading to occurrence of noise. Therefore, the occurrence of noise can be inhibited by performing the control illustrated in FIG. 2.

### Second Embodiment

### (Control Flow in the Present Embodiment)

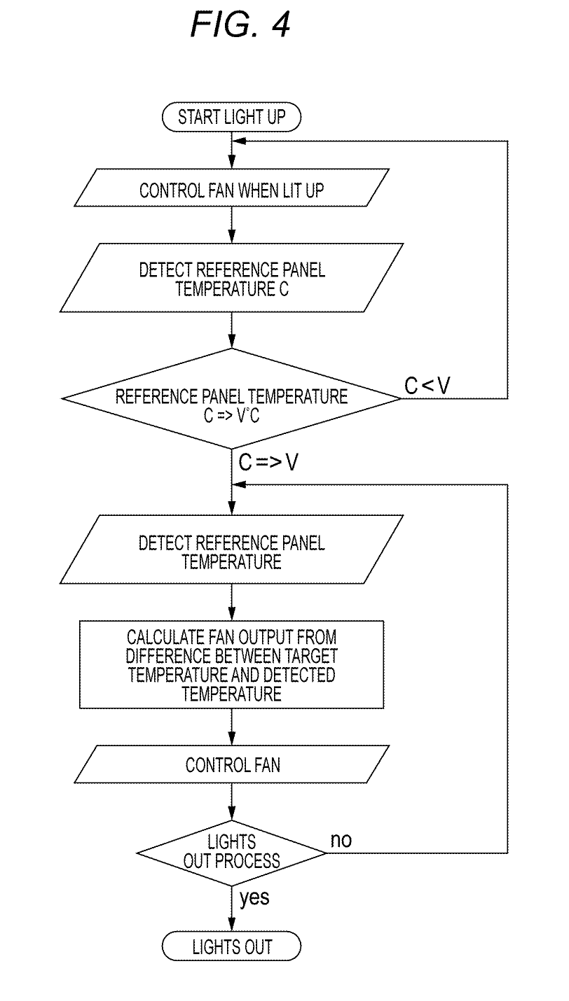

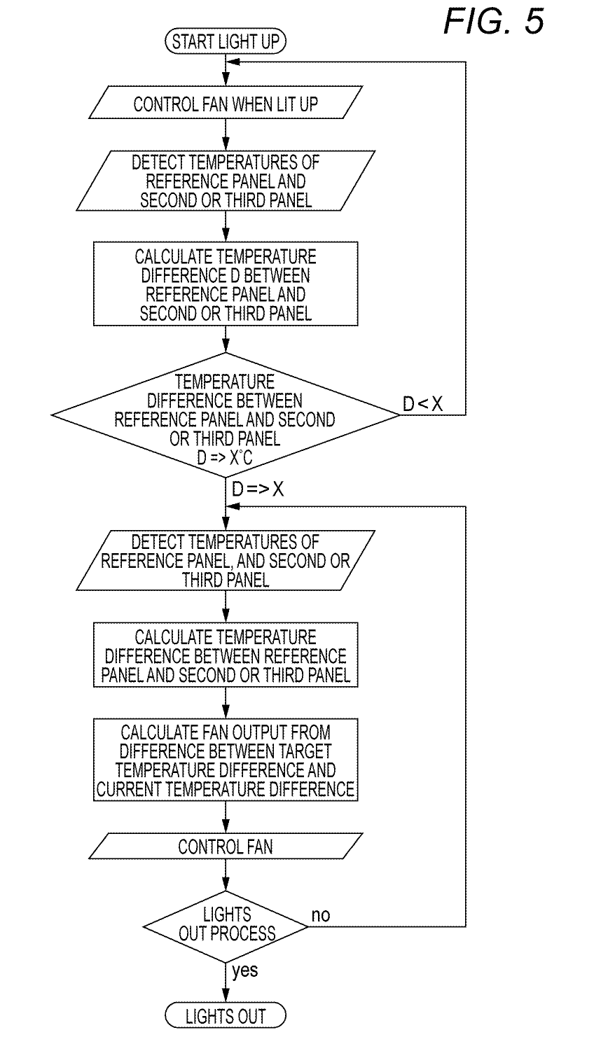

Next, control flows in a second embodiment will be described with reference to FIGS. 4 and 5. FIG. 4 is a control flowchart diagram of a cooling fan 32G that cools a first reference panel 21. FIG. 5 is a control flowchart diagram of a cooling fan 32R or 32B that cools a second panel 22 or a third panel 23, respectively.

First, the control flowchart of the cooling fan 32G for the first reference panel 21 of FIG. 4 will be described.

Immediately after an image display apparatus 1 is activated and a light source is lit up, the cooling fan 32G cools the first reference panel 21 with preset initial fan output.

After light up start, it is assumed that a temperature C of the first reference panel 21 detected by a temperature detecting unit 41G is equal to or higher than a temperature V in consideration of a target temperature 43G of the first reference panel 21 and an output gain of feedback control of the cooling fan 32G. After that, the feedback control is performed on the basis of the following difference. One of the bases of the difference is output necessary for maintaining the target temperature 43G of the first reference panel 21. The other is the target temperature 43G of the first reference panel 21 and the current temperature C detected by the temperature detecting unit 41G. The cooling fan 32G is controlled by the feedback control for adjusting the output according to the difference between the two bases.

The feedback control of the output to the cooling fans 32R and 32B continues until a lights-out instruction is provided to the image display apparatus 1.

Next, the control flowchart of the cooling fans 32R and 32B for the second panel 22 and the third panel 23 of FIG. 5 will be described, respectively.

Immediately after the image display apparatus 1 is activated and the light source is lit up, the cooling fans 32R and 32B cool the second panel 22 and the third panel 23 with preset initial fan output, respectively.

It is assumed that a time elapses that is set in consideration of the output of the light source and the initial output of the cooling fans 32R and 32B. After this, the cooling fans 32R and 32B are controlled by the feedback control that adjusts output according to a difference between the following two bases. One is output necessary for maintaining the target temperature differences 43R and 43B of the first reference panel 21, and the second and third panels 22 and 23, respectively. The other is temperature differences calculated from the target temperature differences 43R and 43B and the current temperatures detected by the temperature detecting units 41G, 41R, and 41B for detecting the temperatures of respective panels.

The feedback control of the output to the cooling fans 32R and 32B continues until a lights-out instruction is provided to the image display apparatus 1.

### (Effects Obtained by the Present Embodiment)

According to the control flow of the present embodiment, each cooling fan is driven with prescribed output until a certain time elapses from light up start of the light source. Therefore, even when the panel temperature immediately after the light up start deviates from the target temperature, the output of the cooling fan does not become extremely high, and thus it is possible to inhibit noise generated when the image display apparatus is lit up. This also applies to the second embodiment.

Furthermore, in the present embodiment, each cooling fan is driven with prescribed output from the light up start of the light source until the temperature of the reference panel and the temperature difference between the reference panel and each panel reach the temperature at which noise is not generated even if the cooling fan is driven by the feedback control. Therefore, it is possible to inhibit noise and temperature rise of the panel during light up regardless of an environmental temperature.

That is, in the present embodiment, a fan output adjusting unit 42 does not perform the above-described control until the temperature of the first reference panel 21 and the temperature difference between the first reference panel 21 and the second panel 22 exceed a predetermined value. Then, when the temperature difference between the first reference panel 21 and the second panel 22 exceeds the predetermined value, the fan output adjusting unit 42 performs the above-described control.

### (Modification)

Although the preferred embodiments of the present disclosure have been described above, the present disclosure is not limited to these embodiments, and various modifications and changes may be made within the scope of the spirit of the present disclosure.

For example, in the present embodiment, as a threshold for changing the control of the cooling fan from the initial fan output to the feedback control, only one of the time from the light up start of the image display apparatus and the temperature of each panel is used; however, two thresholds may be used together. Alternatively, another event such as an environmental temperature may be set as the threshold.

Note that the fan output adjusting unit 42 may be configured, when the temperature difference between the first reference panel 21 and the second panel 22 is T₁₋₂ [° C.], to control a panel cooling unit 30 so as to satisfy the following conditional expression:

2<T₁₋₂<10 (1)

or

4<T₁₋₂<8 (1a).

Similarly, the fan output adjusting unit 42 may be configured, when the temperature difference between the first reference panel 21 and the third panel 23 is T₁₋₃[° C.], to control the panel cooling unit 30 so as to satisfy the following conditional expression:

2<T₁₋₃<8 (2)

or

4<T₁₋₃<6 (2a).

Furthermore, the fan output adjusting unit 42 preferably controls the cooling unit such that the temperature increases in order of a first image modulation element, a third image modulation element, and a second image modulation element on the basis of detection results made by the temperature detecting units. In terms of color light, the control unit preferably performs the feedback control so as to maintain a state where the temperature increases in order of green color light, blue color light, and red color light.

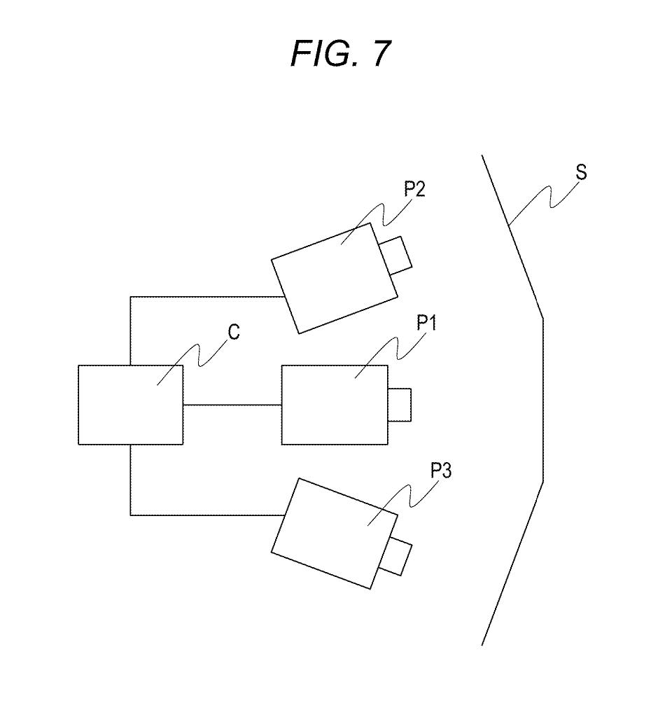

Note that the control flow described in each of the embodiments described above can be applied to an image display system illustrated in FIG. 7 in addition to the image display apparatus illustrated in FIG. 6. In the image display system illustrated in FIG. 7, S is a screen that serves as a projection surface, PJ1 to PJ3 are projectors, and C is a control apparatus for controlling each projector. The control flow described in each of the embodiments described above may be applied to all or one of PJ1 to PJ3. Although the image display system as illustrated in FIG. 7 includes a plurality of projectors, the image display system may include one projector.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-022614, filed Feb. 9, 2017, which is hereby incorporated by reference herein in its entirety.

What is claimed is:

1. An image display apparatus comprising:
a light source unit configured to emit first color light, second color light, and third color light with wavelengths different from each other;
a first image modulation element in which the first color light enters;
a second image modulation element in which the second color light enters;
a third image modulation element in which the third color light enters;
a cooling unit configured to cool the first, second, and third image modulation elements;
a temperature detecting unit configured to detect temperatures of the first, second, and third image modulation elements; and
a control unit configured to control the cooling unit on the basis of a detection result made by the temperature detecting unit, such that a temperature difference between the first and second image modulation elements becomes equal to or greater than a predetermined temperature difference, and a temperature difference between the first and third image modulation elements becomes equal to or greater than a predetermined temperature difference,
wherein the first color light is green color light, the second color light is red color light, and the third color light is blue color light, and
wherein on the basis of the detection result made by the temperature detecting unit, the control unit controls the cooling unit such that the temperature increases in order of the first image modulation element, the third image modulation element, and the second image modulation element.

2. The image display apparatus according to claim 1,
wherein the control unit controls the cooling unit to satisfy
2<T₁₋₂<10,
wherein T₁₋₂ is the temperature difference between the first and second image modulation elements.

3. The image display apparatus according to claim 1,
wherein the control unit controls the cooling unit to satisfy
2<T₁₋₃<8,
wherein T₁₋₃ is the temperature difference between the first and third image modulation elements.

4. The image display apparatus according to claim 1,
wherein, until a predetermined time elapses since the light source unit is lit up, the control unit does not control the cooling unit such that the temperature difference between the first and second image modulation elements based on the detection result made by the temperature detecting unit becomes equal to or greater than the predetermined temperature difference, and the temperature difference between the first and third image modulation elements becomes equal to or greater than the predetermined temperature difference, and the control unit performs the control after the predetermined time elapses.

5. The image display apparatus according to claim 1,
wherein, until the temperature difference between the first and second image modulation elements exceeds a predetermined value, the control unit does not control the cooling unit such that the temperature difference between the first and second image modulation elements based on the detection result made by the temperature detecting unit becomes equal to or greater than the predetermined temperature difference, and the temperature difference between the first and third image modulation elements becomes equal to or greater than the predetermined temperature difference, and the control unit performs the control when the temperature difference between the first and second image modulation elements exceeds the predetermined value.

6. The image display apparatus according to claim 1,
wherein the cooling unit includes: a first cooling unit configured to cool the first image modulation element; a second cooling unit configured to cool the second image modulation element; and a third cooling unit configured to cool the third image modulation element, and
wherein the control unit controls cooling capacity of the first cooling unit, the second cooling unit, and the third cooling unit.

7. The image display apparatus according to claim 6,
wherein the first cooling unit is a first cooling fan, the second cooling unit is a second cooling fan, and the third cooling unit is a third cooling fan, and
wherein the control unit controls a rotating speed of the first cooling fan, the second cooling fan, and the third cooling fan.

8. The image display apparatus according to claim 1,
wherein the light source unit comprises:
an excitation light source unit; and
a phosphor unit configured to convert part of excitation light from the excitation light source unit into fluorescent light different from the excitation light in wavelength, and to emit the fluorescent light and unconverted light identical to the excitation light in wavelength.

9. The image display apparatus according to claim 8,
wherein the excitation light source unit includes a solid-state light source that emits blue color light, and
wherein the phosphor unit includes a yellow color phosphor that emits green color light and red color light.

10. An image display system comprising:
an image display apparatus;
a projection surface on which light from the image display apparatus is projected; and
a control apparatus configured to control the image display apparatus,
wherein the image display apparatus comprises:
a light source unit configured to emit first color light, second color light, and third color light with wavelengths different from each other;
a first image modulation element in which the first color light enters;
a second image modulation element in which the second color light enters;
a third image modulation element in which the third color light enters;
a cooling unit configured to cool the first, second, and third image modulation elements;
a temperature detecting unit configured to detect temperatures of the first, second, and third image modulation elements; and
a control unit configured to control the cooling unit on the basis of a detection result made by the temperature detecting unit, such that a temperature difference between the first and second image modulation elements becomes equal to or greater than a predetermined temperature difference, and a temperature difference between the first and third image modulation elements becomes equal to or greater than a predetermined temperature difference,
wherein the first color light is green color light, the second color light is red color light, and the third color light is blue color light, and
wherein on the basis of the detection result made by the temperature detecting unit, the control unit controls the cooling unit such that the temperature increases in order of the first image modulation element, the third image modulation element, and the second image modulation element.
